(19) United States
(12) Patent Application Publication
(10) Pub. No.: US 2022/0407692 A1
(43) Pub. Date: Dec. 22, 2022

(54) MULTIPLE DEVICE COLLABORATION AUTHENTICATION

(71) Applicant: International Business Machines Corporation, Armonk, NY (US)

(72) Inventors: Shikhar Kwatra, San Jose, CA (US); Jennifer L. Szkatulski, Rochester, MI (US); Saurabh Yadav, Bangalore (IN); Raghuveer Prasad Nagar, Kota (IN)

(21) Appl. No.: 17/348,986

(22) Filed: Jun. 16, 2021

(51) Int. Cl. H04L 9/08

(52) U.S. Cl. CPC H04L 9/0877; H04L 9/0863; H04L 9/085; H04L 9/0866

(57) ABSTRACT

An approach to multi-device collaboration authentication may be provided. The approach may include generating a password in response to a user requesting access to a service or application on a primary device. The approach may include dynamically determining whether secondary devices are located physically near a primary device. The generated password may be segmented into two or more parts, based on the number of secondary devices the physically located near the primary device. A password segment can be sent to the primary device and another segment of the password can be sent to the secondary device determined to be physically near the primary device. The approach can include receiving the password segments in prescribed manner to provide authentication and grant access to the requested application or service.

### BACKGROUND OF THE INVENTION

The present invention relates generally to the field of user authentication, more specifically to multiple device collaboration to authenticate a user in real-time.

User authentication is an important part of any physical or electronic security system. In many systems, a simple method of user authentication is when a user inputs a username and a password to authenticate their identity or allow a transaction to occur. Another method includes two-factor authentication. Two-factor authentication involves the user inputting a username and password and an additional token such as a code sent to an email or short message service address. Another type of two-factor authentication involves a user entering their username and password, along with a connected token that connects to the computing device requesting the authentication (e.g., a universal service bay thumb drive, common access card, etc.).

### SUMMARY

Embodiments of the present disclosure include a computer-implemented method for real time multi-device collaboration authentication. The computer-implemented method includes generating a one-time password. The computer-implemented method further includes segmenting the one-time password into at least two password segments. The computer-implemented method further includes sending a first password segment to a primary computing device. The computer-implemented method further includes determining whether a secondary computing device is within a predetermined distance to the primary computing device. Lastly, the computer implemented method includes if it is determined that the secondary computing device is within the predetermined distance to the primary computing device, the computer implemented method includes sending a second password segment to the secondary computing device.

According to another embodiment of the present invention, a computer program product for real time multi-device collaboration authentication is disclosed. The computer program product includes one or more computer readable storage media and program instructions stored on the one or more computer readable storage media. The computer program product includes instructions to generate a one-time password. The computer program product further includes instructions to segment the one-time password into at least two password segments. The computer program product further includes instructions to send a first password segment to a primary computing device. The computer program product further includes instructions to determine whether a secondary computing device is within a predetermined distance to the primary computing device. Lastly, if it is determined that the secondary computing device is within the predetermined distance to the primary computing device, the computer program product further includes instructions to send a second password segment to the secondary computing device.

According to another embodiment of the present invention, a computer system for real time multi-device collaboration authentication is disclosed. The computer system includes one or more computer processors, one or more computer readable storage media, and program instructions stored on the computer readable storage media for execution by at least one of the one or more processors. The computer system includes program instructions to generate a one-time password. The computer system further includes program instructions to segment the one-time password into at least two password segments. The computer system further includes program instructions to send a first password segment to a primary computing device. The computer system further includes program instructions to determine whether a secondary computing device is within a predetermined distance to the primary computing device. Lastly, if it is determined that the secondary computing device is within the predetermined distance to the primary computing device, the computer system further includes program instructions to send a second password segment to the secondary computing device.

### BRIEF DESCRIPTION OF THE DRAWINGS

FIG. 1 is a functional block diagram of a real-time multi-device collaboration authentication environment, generally designated 100, in accordance with an embodiment of the present invention.

FIG. 2 is a functional block diagram of a multi-device collaboration authentication engine, generally designated 200, in accordance with an embodiment of the present invention.

FIG. 3 is flowchart of a method for real-time multi-device collaboration authentication environment 300, in accordance with an embodiment of the present invention.

FIG. 4 is a functional block diagram of an exemplary computing system 400 within a real-time multi-device collaboration authentication environment, in accordance with an embodiment of the present invention.

FIG. 5 is a diagram depicting a cloud computing environment 50, in accordance with an embodiment of the present invention.

FIG. 6 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Embodiments presented herein recognize a real-time multiple device authentication method. Some current authentication methods may have multiple factor capabilities; however, they lack the extra layer of security provided by the requirement of one or more devices in physical proximity to the device requesting the authentication. For example, a user may request access to their email, via a smartphone. An authentication service, associated with the email service, may require the smartphone be registered with an authentication service. In addition to the smartphone, the user's smart watch may be registered with the authentication service. The authentication service may identify the smartphone is in the required physical proximity to the smartphone, which is connected to the smartwatch. The required physical proximity is a predetermined distance or within a threshold distance of another device. The identification of this connection may be sufficient to authenticate the user's request to access the email, due to the authentication service recognizing the close physical proximity of the smart watch to the smart phone.

In another embodiment of the invention, a generated password or one time token may be segmented. One segment of the password is sent to a primary device and another segment of the password is sent to a secondary device registered with the authentication service and identified to be within close physical proximity to one another. For example, a user may input their login information (e.g., username and password) on a device that is registered with an authentication service. The authentication service verifies that the user's login information is correct, prompting a one-time password to be generated, in which the one-time password is then segmented into two parts. The segmented password is sent to the device requesting access and a secondary device (e.g., smart watch, tablet, health monitoring device, etc.), registered with the authentication service, that is in close physical proximity to the user at the time the request is made.

In another embodiment of the invention, the one-time password may be input into the authentication service in a specific order to allow for authentication. For example, a segmented password is sent to three devices in close physical proximity to one another. Each device receives a different segment of the password. In this embodiment, the user may select the order in which the password segments must be received, the order of password segments is only known to the user. To further illustrate the example, imagine the following: A user has requested access to her banking information via her the financial institution's application on her tablet. The financial institution has an authentication service associated with the tablet which detects that her smartphone and smart watch are in close physical proximity to the tablet (e.g., the smart phone and smart watch are connected to the tablet via a short distance mechanism). A one-time password is generated and segmented. Then the password is sent to the three devices with the first segmented piece being sent to her watch, the second being sent to her smartphone, and the third segmented part being sent to her tablet. The user inputs the password segments in the correct order granting her access to her banking information.

In an embodiment, a password segment may be sent to a first device, a second device, and a third device. The user must input the password segments in the correct order to gain access or be authenticated. The correct order of the segment inputs can be determined by the user prior at registration (e.g., the segment from the second device, first device, then the third device) or the order the segments must be input can be dynamically determined by the system (e.g., the segment from the device that has been in the physical possession of the user the longest, followed by the device that has been in the physical possession of the user the shortest.) Further, in an embodiment, the password segment from the first device must be input into the second device, while the segment sent to the second device must be input into the first device to gain access or be authenticated.

In another embodiment of the invention, the system may dynamically determine which users devices may receive segments and/or the number of segments, if any, of the one-time password. For example, the user may have multiple registered devices within the required physical proximity to receive a one-time password segment. The system may dynamically consider whether a device will receive a one-time password segment based on the time the device has been in the user's possession, the proximity to the primary device requesting authentication, the digital identification tag of the device, the amount of time the device has been within proximity to the primary device requesting authentication, etc. It should be noted, multiple internet of things devices may determine the exact location of the secondary devices registered to receive segments of the one-time password, for example, if multiple devices are on the same wireless network, each may triangulate the position of the devices of the registered secondary devices to determine the physical proximity of the secondary devices to the primary device.

In another embodiment of the invention, the authentication system may factor the historical access of the primary device when determining which secondary devices to send one time password segments. For example, if a user's registered tablet has never requested access to a network resource, this could be considered suspicious activity. The system may trigger a one-time password to be sent to the user's laptop, smartphone, and health monitoring device, in an attempt to prevent unauthorized access of the resource.

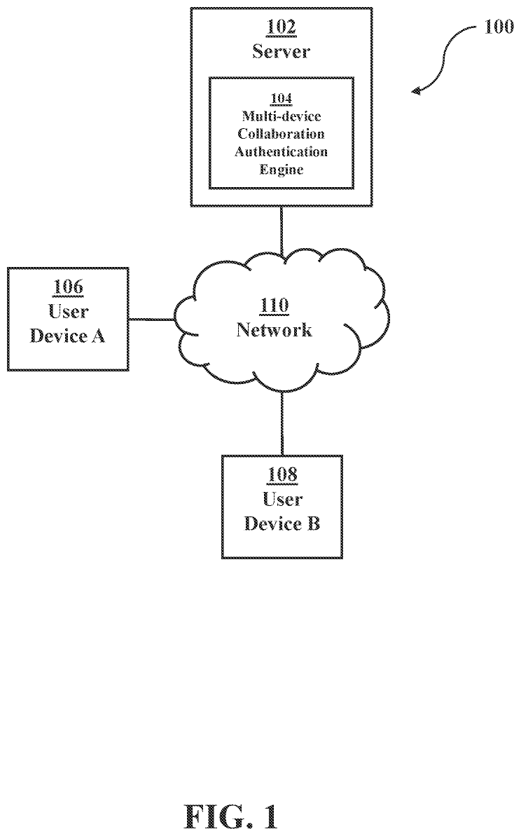

Referring now to the Figures, FIG. 1 is a functional block diagram generally depicting real-time multi-device collaboration authentication environment 100. Real-time multi-device collaboration authentication environment 100 comprises multi-device collaboration authentication engine 104 operational on server 102, user device A 106, user device B 108, all interconnected over network 110.

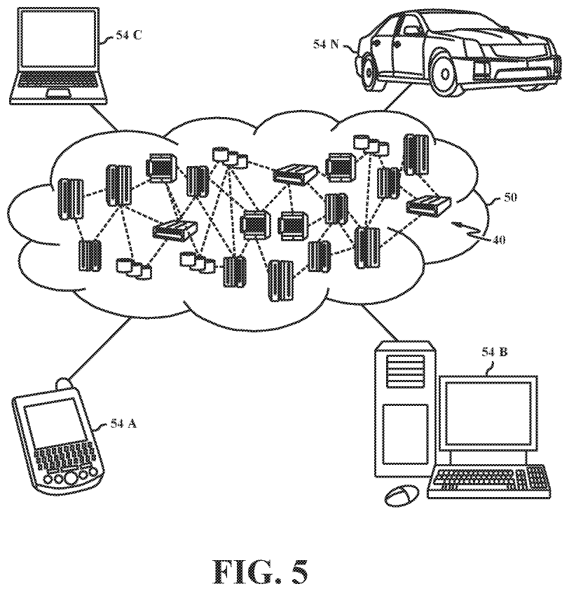

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system such as in cloud computing environment 50 (depicted in FIG. 5). In an embodiment, server 102 can represent a computing system utilizing clustered computers and components (e.g., database server computers, application server computers, etc.) that act as a single pool of seamless resources when accessed within real-time multi-device collaboration authentication environment 100. In another embodiment, server 102 can be a laptop computer, a tablet computer, a netbook computer, a personal computer, a desktop computer, or any programmable electronic device or combination of programmable electronic devices capable of executing machine readable program instructions and communicating with each other, as well as user device A 106 and user device B 108 and other computing devices (not depicted) within real-time multi-device collaboration authentication environment 100 via network 110. It should be noted, while only a single server 102 is shown in FIG. 1, in other embodiments, multiple servers or other computing devices can be present within real-time multi-device collaboration authentication environment 100.

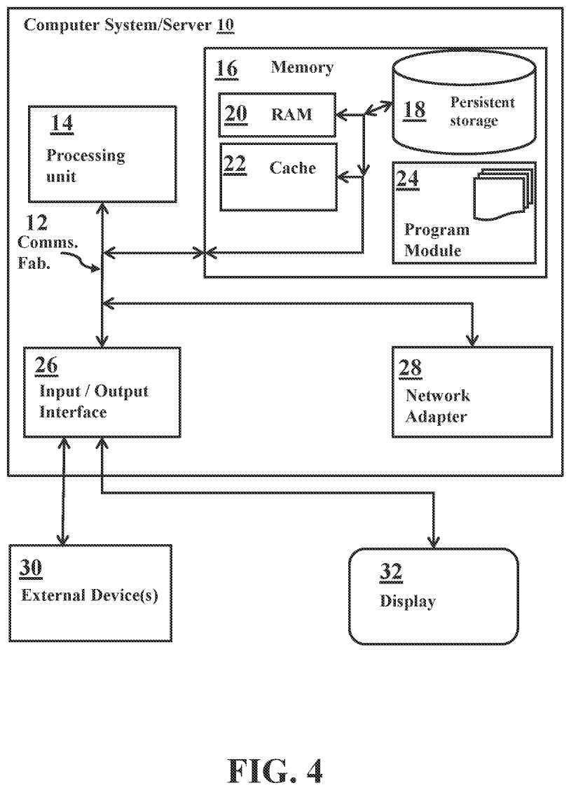

Server 102 may include components as depicted and described in further detail with respect to computer system 10 in FIG. 4. Server 102 may include components as depicted and described in further detail with respect to cloud computing node 40 of cloud computing environment 50 in FIG. 5.

User device A 106 and user device B 108 can be any device capable of communication with multi-device collaboration authentication engine 104 via network 110. For example, user device A 106 and user device B 108 can be a desktop computer, laptop computer, smartphone, tablet, smartwatch, health monitoring device, smart cloth, smart glasses, smart earphones or headphones, video game console, etc. It should be noted, while only two user devices are shown any number of user devices may be present within real-time multi-device collaboration authentication environment 100 (e.g., 1, 2, n . . . n+1).

In an embodiment, user device A 106 and user device B 108 can be any internet of things device capable of accessing multi-device collaboration authentication engine 104. For example, user device A 106 may be considered the “primary” device if the user is attempting to access a service or application from user device A 106 and user device B 108 may be considered the “secondary” device that is in proximity to the primary device. User device B 108 may be on the same wireless network as user device A 106. User device B 108 may be registered with multi-device collaboration authentication engine 104. It should be noted, in this scenario user device B 108 may be any device capable of transmitting a password segment in a human understandable manner.

Network 110 can be a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between server 102, user device A 106, and external computing devices (not shown) within real-time multi-device collaboration authentication environment 100.

Multi-device collaboration authentication engine 104 is a computer program capable of providing authentication of a user by collaboration of multiple devices. In an embodiment, multi-device collaboration authentication engine 104 may be operational on server 102 or multiple servers (not shown) connected via network 110. In some embodiments, multi-device collaboration authentication engine 104 may be present on multiple devices, such as user device A 106 and user device B 108. In an embodiment, multi-device collaboration authentication engine 104 may act as a registration program which allows multi-device collaboration authentication engine 104 to monitor the physical location of user device A 106 and user device B 108. For example, an online video gaming platform might require a user to register multiple devices, such as user device A 106 and user device B 108. If a user attempts to log in to the platform from an unknown device, multi-device collaboration authentication engine 104 may determine the location of user device A 106 and user device B 108 via global positioning system built into each device.

In an embodiment, multi-device collaboration authentication engine 104 can dynamically determine which user device can be used to receive one time passwords. For example, multi-device collaboration authentication engine 104 may have a machine learning capability, which allows for it to monitor which devices are typically in the user's possession when the user attempts to access a service or application and where the user is when access is attempted. In another example, if a user attempts to access a service during business hours via their laptop, the user may have their smart phone and smart watch nearby. In this scenario, multi-device collaboration authentication engine 104 would learn not to send a password segment to their vehicle, which may be located physically nearby, but not accessible. In another example, if a user is using their home desktop to access a service, multi-device collaboration authentication engine 104 would learn via a location monitoring capability or proximity sensor to send a password segment to a virtual assistant device in the same room as the desktop computer, rather than a tablet which may be on a different room. Multi-device collaboration authentication engine 104 may learn this through a supervised learning capability which prompts the user to choose which physically nearby devices to send a password. The machine learning capabilities of multi-device collaboration authentication engine 104 may be based on a deep learning model, such as a neural network (e.g., a convolutional neural network) and the like.

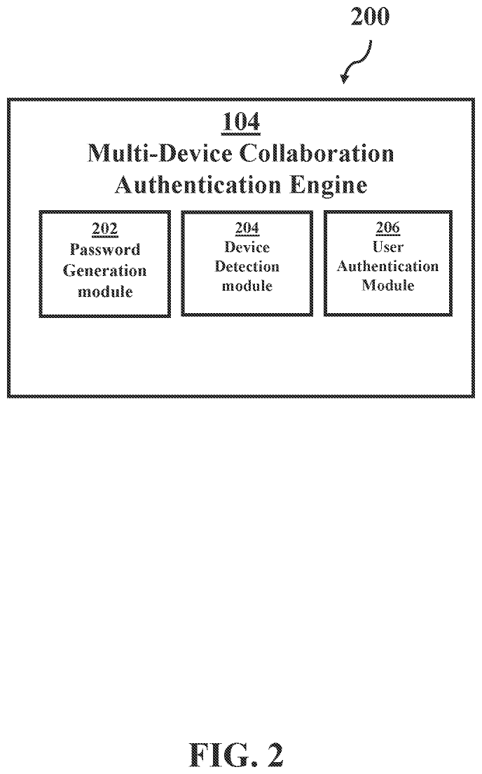

FIG. 2 is block diagram 200 comprised of multi-device collaboration authentication engine 104. Multi-device collaboration authentication engine 104 can be comprised of password generation module 202, device detection module 204, and user authentication module 206.

Password generation module 202 is a computer module that can generate a password and segment the generated password into multiple segments in response to an authentication request. In an embodiment, password generation module 202 can receive the login credentials of a user via user authentication module 206. In response to receiving verification of the login credentials, password generation module 202 can generate a one-time password or token. It should be noted, the terms one-time password and token will be used interchangeably within this description and should be treated as the same. The one time password can be segmented based on the number of registered user devices active within physical proximity to the user device requesting access to the service or application associated with the multi-device collaboration engine. It should be noted, password generation module 202 can receive the number of password segments required from device detection module 204. In another embodiment, password generation module 202 can generate multiple distinct passwords in response to the number of devices detected by password generation module 202.

Device detection module 204 is a computer module that can be configured to detect the physical proximity of one or more registered user devices in respect to a primary user device. In an embodiment, device detection module 204 can determine if secondary devices are physically located nearby (i.e., within a predetermined distance) to a primary device. For example, if a user is using a tablet (“the primary device”) to access a service, device detection module 204 can see which registered devices are physically near the primary device. This can be accomplished by seeing which devices are connected via a short distance connection method (e.g., Bluetooth®, Near Field Communication®, etc.). In this scenario, device detection module 204 can determine the tablet is connected via Near Field Communication® protocol to a smart watch and a pair of smart earbuds both of which are registered with the authentication service.

In another embodiment, device detection module 204 may be present on multiple devices registered with a multi-device collaboration authentication service. For example, if the user is attempting to access a service via a registered laptop connected to a home wireless network, device detection module 204 may look for other devices present on the home wireless network. Once the devices are located, device detection module 204 may attempt to triangulate the signals of the other devices to determine which other devices are nearby the primary device.

User authentication module 206 is a computer module that can be configured to receive the segmented password and authenticate a user. In an embodiment, user authentication module 206 can send password segments to primary devices and detected secondary devices. In an embodiment, user authentication module 206 can receive user login credentials or receive a notification from an application or service that the user's initial login credentials are correct. Upon receiving notice, user authentication module 206 can prompt password generation module 202 to generate a password and segment the password. User authentication module 206 can further send the password segments to one or more devices determined to by physically nearby (i.e., within a predetermined distance) to the primary device.

In an embodiment, user authentication module 206 can receive the registration of new devices to the user account. For example, if a user registers a smart ring and a smart watch, user authentication module 206 can prompt the user to input the maximum distance (e.g., 0.5 meters, 1.5 meters, etc.) away from the primary device required for the device to receive a password segment. Additionally, user authentication module 206 can ingest historical preferences and recommend maximal distances in which it will send the password segment to the user device. Further, in addition to requiring a secondary device to be within a predetermined distance of a primary device in order to receive a password segment, user authentication module 206 can prompt the user for times which it will require user devices to be present in order to access certain services.

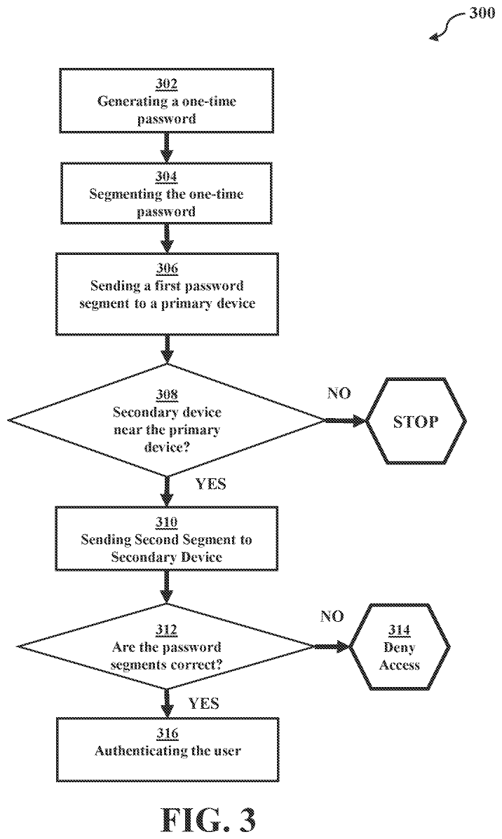

FIG. 3 is a flowchart depicting method 300 for multi-device collaboration authentication, in accordance with an embodiment of the present invention.

At step 302, password generation module 202 generates a one-time password. In an embodiment, password generation module 202 can receive a prompt to generate a password for a user. For example, user authentication module 206 can receive correct user login credentials to a service, which can trigger password generation module 202 to generate a password.

At step 304, password generation module 202 can segment the generated password. In an embodiment, password generation module 202 can segment the password into two segments. In an embodiment, password generation module 202 can segment the password into any number of segments. In an embodiment, the number of password segments generated is equal to a total number of secondary devices within a predetermined distance of the primary device plus the primary device. In another embodiment, password generation module 202 can receive the number of segments needed from multi-device collaboration authentication engine 104 respective to the number of devices that are physically near the primary device, plus the physical device.

At step 306, user authentication module 206 sends the first password segment to the primary device (i.e., user device A 106). In an embodiment, user authentication module 206 can receive a password segment from password generation module 202. The received password segment can be sent to the primary device requesting access to the service or application.

At step 308, device detection module 204 determines whether a secondary device is within the required physical proximity (i.e., within a predetermined distance) to the primary device. In an embodiment, device detection module 204 can find other registered devices associated with the user in close physical proximity to the primary device. For example, device detection module 204 can look at the devices connected to the primary device (e.g., a smartphone) via a Bluetooth® connection such as a smart watch or health monitor. In another example, device detection module 204 can determine if the secondary device is connected to the same wireless network as the primary device.

At step 310, device detection module 204 sends the second segment to a secondary device (i.e., user device B 108). If device detection module determines there is a secondary device within close physical proximity to the primary it can send a password segment to the secondary device over a wireless network or a short distance connection (e.g., Bluetooth®).

At step 312, user authentication module 206 receives the password segments and determines whether the password segments are correct. For example, if the a password segment from the primary device may be input into a first field and the password segment from the secondary device may be input into a second field. In another embodiment, the password segment from the primary device may be input into the secondary device, while the password segment from the secondary device may be input into the primary device. User authentication module 206 ensures the password segments are correct and input in the correct order and manner.

At step 314, if user authentication module 206 determines the password segments are incorrect or the order of password segments is incorrect, it will deny access.

At step 316, user authentication module 206 authenticates the user based on the input of the password segments. Authentication can include granting access to a resource. For example, authentication can allow a user access to a database or personal computer. Further, authentication can allow access to a network resource.

FIG. 4 depicts computer system 10, an example computer system representative of server 102, user device A 106, and user device B 108. Computer system 10 includes communications fabric 12, which provides communications between processing unit 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processing unit 14, cache 22, memory 16, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes persistent storage 18, random access memory (RAM) 20, cache 22 and program module 24. In general, memory 16 can include any suitable volatile or non-volatile computer readable storage media. Cache 22 is a fast memory that enhances the performance of processing unit 14 by holding recently accessed data, and data near recently accessed data, from memory 16. As will be further depicted and described below, memory 16 may include at least one of program module 24 that is configured to carry out the functions of embodiments of the invention.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

Program instructions and data used to practice embodiments of the present invention may be stored in persistent storage 18 and in memory 16 for execution by one or more of the respective processing unit 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 32 provides a mechanism to display data to a user and may be, for example, a computer monitor or virtual graphical user interface.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

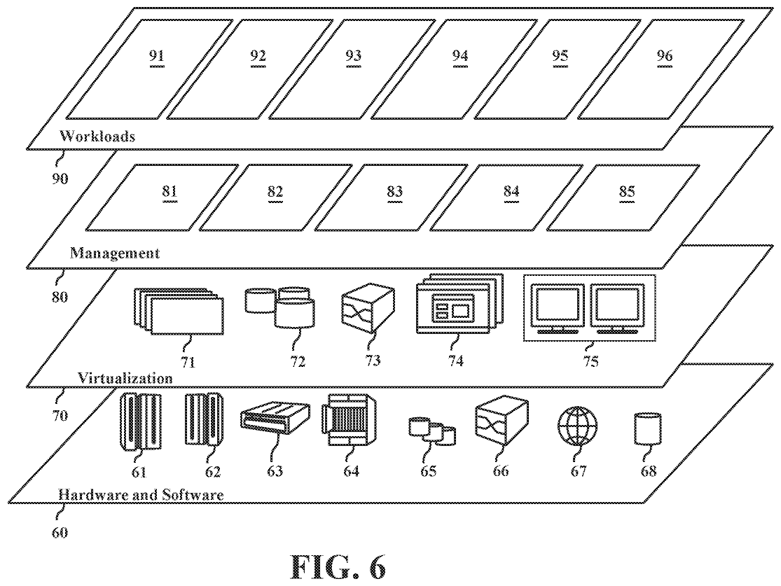

Referring now to FIG. 6, a set of functional abstraction layers provided by cloud computing environment 50 (depicted in FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and multi-device collaboration authentication 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

What is claimed is:

1. A computer-implemented method for multi-device collaboration authentication, the method comprising:
generating, by the processor, a one-time password;
segmenting, by the processor, the one-time password into at least two password segments;
sending, by the processor, a first password segment to a primary computing device;
determining, by the processor, whether a secondary computing device is within a predetermined distance to the primary computing device; and
responsive to determining that the secondary computing device is within the predetermined distance to the primary computing device, sending, by the processor, a second password segment to the secondary computing device.

2. The computer-implemented method of claim 1, further comprising:
authenticating, by the processor, a user, based, at least in part, on receiving the at least two password segments from the primary computing device.

3. The computer-implemented method of claim 2, wherein authenticating, by the processor, the user, is further based on receiving the first password segment and the second password segment from the primary computing device in a predetermined order.

4. The computer-implemented method of claim 1, further comprising:
authenticating, by the processor, a user, based, at least in part, on receiving the first password segment sent to the primary computing device from the secondary computing device, and receiving the second password sent to the secondary computing device from the primary computing device.

5. The computer-implemented method of claim 1, wherein determining whether the secondary device is within the required physical proximity further comprises:
determining, by the processor, dynamically whether the secondary computing device is on a same network as the primary computing device; and
responsive to determining the secondary computing device is on the same network as the primary computing device, determining, by the processor, whether the secondary computing device is within in a predetermined physical location, based on historical data associated with the primary computing device and the secondary computing device.

6. The computer-implemented method of claim 1, further comprising:
determining, by the processor, whether the secondary computing device can receive the second password segment, wherein the determining is based, at least in part, on one of the following factors: time of day, duration that the secondary computing device has been in physical possession of the user, and geographic location of the secondary computing device.

7. A computer system for multi-device collaboration authentication, the system comprising:
a memory; and
a processor in communication with the memory, the processor being configured to perform operations comprising:
generate a one-time password;
segment the one-time password into at least two password segments;
send a first password segment to a primary computing device;
determine whether a secondary computing device is within a predetermined distance to the primary computing device; and
responsive to determining that the secondary computing device is within the predetermined distance to the primary computing device, send a second password segment to the secondary computing device.

8. The computer system of claim 7, further comprising operations to:
authenticate a user, based, at least in part, on receiving the at least two password segments from the primary computing device.

9. The computer system of claim 8, wherein authenticating the user is further based on receiving the first password segment and the second password segment from the primary computing device in a predetermined order.

10. The computer system of claim 7, further comprising operations to:
authenticate a user, based, at least in part, on receiving the first password segment sent to the primary computing device from the secondary computing device, and receiving the second password sent to the secondary computing device from the primary computing device.

11. The computer system of claim 7, wherein determining whether the secondary device is within the required physical proximity further comprises operations to:
determine dynamically whether the secondary computing device is on a same network as the primary computing device; and
responsive to determining the secondary computing device is on the same network as the primary computing device, determine whether the secondary computing device is within in a predetermined physical location, based on historical data associated with the primary computing device and the secondary computing device.

12. The computer system of claim 7, further comprising operations to:
determine whether the secondary computing device can receive the second password segment, wherein the determining is based, at least in part, on one of the following factors: time of day, duration that the secondary computing device has been in physical possession of the user, and geographic location of the secondary computing device.

13. A computer program product for multi device collaboration authentication, the computer program product comprising one or more computer readable storage devices and program instructions stored on the one or more computer readable storage devices executable by a processor to cause the processors to perform a function, the function comprising:
generate a one-time password;
segment the one-time password into at least two password segments;
send a first password segment to a primary computing device;
determine whether a secondary computing device is within a predetermined distance to the primary computing device; and
responsive to determining that the secondary computing device is within the predetermined distance to the primary computing device, send a second password segment to the secondary computing device.

14. The computer program product of claim 13, further comprising instructions to:
authenticate a user, based, at least in part, on receiving the at least two password segments from the primary computing device.

15. The computer program product of claim 13, wherein authenticating the user is further based on receiving the first password segment and the second password segment from the primary computing device in a predetermined order.

16. The computer program product of claim 15, further comprising instructions to:
authenticate a user, based, at least in part, on receiving the first password segment sent to the primary computing device from the secondary computing device, and receiving the second password sent to the secondary computing device from the primary computing device.

17. The computer program product of claim 15, wherein determining whether the secondary device is within the required physical proximity further comprises instructions to:
determine dynamically whether the secondary computing device is on a same network as the primary computing device; and
responsive to determining the secondary computing device is on the same network as the primary computing device, determine whether the secondary computing device is within in a predetermined physical location, based on historical data associated with the primary computing device and the secondary computing device.

18. The computer program product of claim 16, further comprising instructions to:
determine whether the secondary computing device can receive the second password segment, wherein the determining is based, at least in part, on one of the following factors: time of day, duration that the secondary computing device has been in physical possession of the user, and geographic location of the secondary computing device.
